(19) United States
(12) Patent Application Publication
(10) Pub. No.: US 2025/0199653 A1
(43) Pub. Date: Jun. 19, 2025

(54) SYSTEM AND METHOD FOR PROVIDING AN ELEMENT IN CORRECT FORMAT ON A USER EQUIPMENT

(71) Applicant: SAMSUNG ELECTRONICS CO., LTD., Suwon-si (KR)

(72) Inventor: Gurmanjeet Singh SIDHU, Noida (IN)

(73) Assignee: SAMSUNG ELECTRONICS CO., LTD., Suwon-si (KR)

(21) Appl. No.: 19/018,847

(22) Filed: Jan. 13, 2025

Related U.S. Application Data
(63) Continuation of application No. PCT/IB2024/061829, filed on Nov. 26, 2024.

(30) Foreign Application Priority Data
Dec. 14, 2023 (IN) 202311085522

(51) Int. Cl. G06F 3/0481; G06F 1/16

(52) U.S. Cl. CPC G06F 3/0481; G06F 1/1677; G06F 2203/04803

(57) ABSTRACT

A system for providing an element on a UE including foldable portions, is provided. The system includes: a processor configured to: identify an angular orientation between first and second foldable portions; detect the element of an application running on the first foldable portion; identify, based on the element being detected as running on the first foldable portion, whether the first foldable portion includes sensors; determine whether the element is displayed on the first foldable portion, based on identifying the first foldable portion does not have the sensors; fuse, based on determining the first foldable portion does not have the sensors, data from the sensors to data corresponding to the element of the application; and control display of the element based on the fused data to provide a correct format of the at least one element on the first foldable portion.

### CROSS-REFERENCE TO RELATED APPLICATIONS

This application is a bypass continuation of International Application No. PCT/IB2024/061829, filed on Nov. 26, 2024, which is based on and claims priority to India Patent Application No. 202311085522, filed on Dec. 14, 2023, in the India National Intellectual Property Administration, the disclosures of which are incorporated by reference herein in their entireties.

### BACKGROUND

### 1. Field

The disclosure relates to display of location information, and more particularly to a system and a method for providing at least one element, in a correct format, on a user equipment.

### 2. Description of Related Art

In recent years, developments in electronic devices have taken place. Such developments have made the electronic devices compact, have fulfilled the demand of users, and have made the life of the users hassle-free. For example, electronic devices like smartphones are developed as foldable phones. Foldable phones are compact, and provide a plurality of foldable portions which provides a bigger space for working to the users, as and when desired. Further, foldable phones may have an inbuilt navigation application, for example, map services. The map services may be used in day-to-day life by the users to reach a target, for example, shopping complexes, theatres, homes, etc. This increases the dependency of the user on the navigation applications. This raises the need to provide accurate location of the target on the foldable phones.

The accurate location of the target in the foldable phones (smartphones) is provided by a plurality of sensors, for example, an Ultra Wide Band (UWB) sensor, a magnetometer, an accelerometer, a gyroscope, and an Inertial Measurement Unit (IMU). The plurality of sensors is used to determine the orientation and movement of the smartphones and thus accurately determine the location and movement of the target. For example, the UWB sensor may be used for indoor positioning. In contrast to Bluetooth Low Energy and Wi-Fi, distance measurement by the UWB sensor uses transit time methodology (Time of Flight, ToF) instead of the measurement of signal strengths (Receive Signal Strength Indicator, RSSI). Further, to locate the target, Two Way Ranging (TWR) may be used to measure the Time of Flight of the UWB signal between radio frequencies (RFs) of two smartphones. TWR may be used in combination with Phase Difference of Arrival (PDoA), which provides a measurement of an Angle of Arrival, may be used to localize the position of the target. Further, the magnetometer may be used to measure the magnetic field of the earth. This sensor helps to provide the orientation of the foldable smart phone, or any other devices, with respect to the magnetic poles of the earth. The sensor may be used in navigation along with the GPS. However, when the movement area is small like indoor navigation, the navigation applications, like the Map Services, may rely on other sensor data to navigate towards the target.

However, the foldable phones have limitations that the plurality of sensors, especially, the IMU sensor, and the magnetometer, responsible for providing the accurate location of the target, are present on only one of the plurality of foldable portions. When the foldable phones are in a partially open condition, the location of the target shown on another foldable portion, which is oriented differently than the foldable portion with the plurality of sensors, becomes inaccurate as the plurality of sensors, for example, accelerometer, gyroscope considers value from the IMU, the magnetometer, are present in another one of the plurality of foldable portions.

Additionally, the plurality of sensors is not able to be embedded on each foldable portion due to space, power, structural and complexity constraints in the foldable phones.

### SUMMARY

Provided are system and a method for providing at least one element, in a correct format, on a foldable user equipment.

This summary is provided to introduce a selection of concepts, in a simplified format, that are further described in the detailed description of the disclosure. This summary is neither intended to identify key or essential concepts of the disclosure and nor is it intended for determining the scope of the disclosure.

According to an aspect of the disclosure, a method of controlling a user equipment (UE) including a plurality of foldable portions, includes: identifying a current state of the UE, wherein the current state of the UE includes an angular orientation between a first foldable portion and a second foldable portion from among the plurality of foldable portions; detecting at least one element of an application running on the first foldable portion; identifying, based on the detecting, whether the first foldable portion includes a plurality of sensors; determining whether the at least one element is displayed on the first foldable portion, based on the identifying indicating the first foldable portion does not have the plurality of sensors; fusing data from the plurality of sensors to data corresponding to the at least one element of the application; and controlling display of the at least one element based on the fused data to provide a correct format of the at least one element on the first foldable portion.

The angular orientation between the first foldable portion and the second foldable portion from the plurality of foldable portions may be less than 180 degrees.

The plurality of sensors may include any one or any combination of an accelerometer sensor, a gyroscope, a magnetometer, an inertial sensor, and an ultra-wideband positioning sensor.

The at least one element of the application may be operated in a multi-window mode on the first foldable portion.

The method may include, prior to detecting the at least one element of the application operating on the first foldable portion from the plurality of foldable portions, determining boundaries of the application running on the UE.

The detecting the at least one element may include: determining boundaries of the application running on the UE; detecting that the application is running in a multi-window mode or a full screen mode on the UE based on the boundaries of the application; detecting first coordinates of the application on the UE based on the determined boundaries of the application, and summing the first coordinates with second coordinates associated with a relative position of the application, wherein the second coordinates are determined with respect to a center position of a view of the at least one element; and detecting the at least one element of the application on the first foldable portion based on a width of the plurality of foldable portions and a number of the plurality of foldable portions.

The fusing the data may include: determining a rotation matrix based on the angular orientation between the first foldable portion and the second foldable portion; and computing the rotation matrix based on an input from the plurality of sensors to fuse the data corresponding to the at least one element of the application.

According to an aspect of the disclosure, a system for providing at least one element on a UE including a plurality of foldable portions, includes: a memory; and at least one processor communicatively coupled with the memory, and configured to: identify a current state of the UE, wherein the current state of the UE includes an angular orientation between a first foldable portion and a second foldable portion from among the plurality of foldable portions; detect the at least one element of an application running on the first foldable portion; identify, based on the at least one element being detected as running on the first foldable portion, whether the first foldable portion includes a plurality of sensors; determine whether the at least one element is displayed on the first foldable portion, based on identifying the first foldable portion does not have the plurality of sensors; fuse, based on determining the first foldable portion does not have the plurality of sensors, data from the plurality of sensors to data corresponding to the at least one element of the application; and control display of the at least one element based on the fused data to provide a correct format of the at least one element on the first foldable portion.

The at least one processor may be further configured to detect the at least one element based on identifying the angular orientation between the first foldable portion and the second foldable portion from the plurality of foldable portions is less than 180 degrees.

The plurality of sensors may include any one or any combination of an accelerometer sensor, a gyroscope, a magnetometer, an inertial sensor, and an ultra-wideband positioning sensor.

The at least one element of the application may be operated in a multi-window mode on the first foldable portion.

The at least one processor may be further configured to, prior to detecting the at least one element of the application operating on the first foldable portion from the plurality of foldable portions, determine boundaries of the application running on the UE.

The at least one processor may be further configured to: determine boundaries of the application running on the UE; detect that the application is running in a multi-window mode or a full screen mode on the UE based on the boundaries of the application; detect first coordinates of the application on the UE based on the determined boundaries of the application, and sum the first coordinates with second coordinates associated with a relative position of the application, wherein the second coordinates are determined with respect to a center position of a view of the at least one element; and detect the at least one element of the application on the first foldable portion based on a width of the plurality of foldable portions and a number of the plurality of foldable portions.

The at least one processor may be further configured to: determine a rotation matrix based on the angular orientation between the first foldable portion and the second foldable portion; compute the rotation matrix based on an input from the plurality of sensors to fuse the data corresponding to the at least one element of the application.

According to an aspect of the disclosure, an apparatus for controlling display of information on a user equipment including a plurality of foldable portions and a sensor provided in a first foldable portion of the plurality of foldable portions, includes: a memory; and at least one processor communicatively coupled with the memory and configured to: identify whether an application is running on the user equipment to display a first element based on an output of the sensor; modify, based on the first element being displayed on a second foldable portion of the plurality of foldable portions, display of the first element based on an angle between the first foldable portion and the second foldable portion.

The at least one processor may be further configured to maintain display of a second element on the first foldable portion based on the output of the sensor without modification.

The at least one processor may be further configured to move display of the first element from the second foldable portion to the first foldable portion, and based on the first element being displayed on the first foldable portion, control the first element to be displayed independent of the angle between the first foldable portion and the second foldable portion.

The output of the sensor may indicate motion of the user equipment.

The output of the sensor may indicate a first orientation corresponding to the first foldable portion.

The at least one processor may be further configured to identify a second orientation corresponding to the second foldable portion based on the output of the sensor and the angle between the first foldable portion and the second foldable portion.

The at least one processor may be further configured to continuously modify display of the first element based on the second orientation.

The apparatus may include the user equipment.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A, 1B, 1C and 1D illustrate a scenario depicting an inaccurate location of a target on a related user equipment (UE);

FIG. 2 illustrates a system communicably coupled with a UE having a plurality of foldable portions, in accordance with an embodiment;

FIG. 3 illustrates a block diagram of the system in connection with the user equipment, in accordance with an embodiment;

FIG. 4 illustrates detecting at least one element of an application on a first foldable portion from the plurality of foldable portions by the system in the UE, in accordance with an embodiment;

FIG. 5 illustrates an angle between the first foldable portion not having a plurality of sensors and a second foldable portion from the plurality of foldable portions having the plurality of sensors in the UE, in accordance with an embodiment;

FIG. 6 illustrates a rotation matrix based on the angle between the first foldable portion and the second foldable portion from the plurality of foldable portions, in accordance with an embodiment;

FIG. 7 illustrates a representation of the at least one element of the application, in the correct format, on the first foldable portion from the plurality of foldable portions of the UE, in accordance with an embodiment;

FIG. 8 illustrates a method performed by the system, in accordance with an embodiment; and

FIGS. 9A and 9B illustrate multiple use cases of the system, in accordance with an embodiment.

### DETAILED DESCRIPTION

Example embodiments of the disclosure are described below with reference to the drawings. It will be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates. Unless otherwise defined, all technical and scientific terms used herein have the same meaning as commonly understood by one of ordinary skilled in the art to which disclosure belongs. The system and examples provided herein are illustrative only and not intended to be limiting.

The term “some” as used herein may be understood as or “one” or “more than one” or “all.” Therefore, the terms “one,” “more than one,” “more than one, but not all” or “all” would fall under the definition of “some.” It should be appreciated by a person skilled in the art that the terminology and structure employed herein is for describing, teaching, and illuminating some embodiments and their specific features and elements and therefore, should not be construed to limit, restrict, or reduce the spirit and scope of the present disclosure.

Terms used herein, such as “includes,” “comprises,” “has,” and similar grammatical variants do not specify an exact limitation or restriction, and do not exclude the possible addition of a plurality of features or elements, unless otherwise stated.

Unless otherwise defined, all terms and especially any technical and/or scientific terms, used herein may be taken to have the same meaning as commonly understood by a person ordinarily skilled in the art.

Reference is made herein to some “embodiments.” It should be understood that an embodiment is an example of a possible implementation of any features and/or elements of the present disclosure. Some embodiments have been described for the purpose of explaining plurality of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, plurality of particular features and/or elements described in connection with plurality of embodiments may be found in one embodiment, or may be found in more than one embodiment, or may be found in all embodiments, or may be found in no embodiments. Although plurality of features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized together in the context of a single embodiment.

Any particular and all details set forth herein are used in the context of some embodiments and therefore should not necessarily be taken as limiting factors to the proposed disclosure.

Embodiments will be described below in detail with reference to the accompanying drawings.

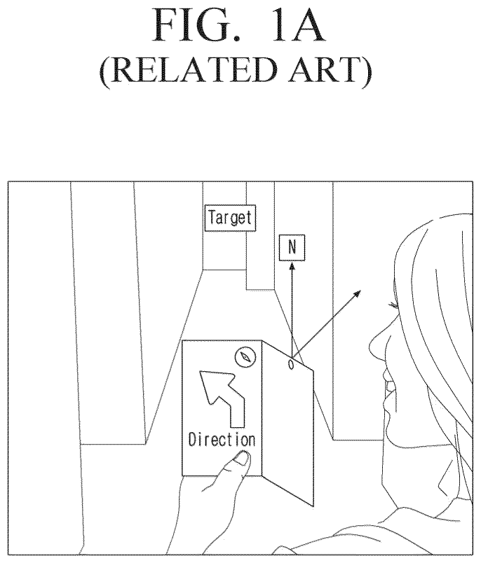

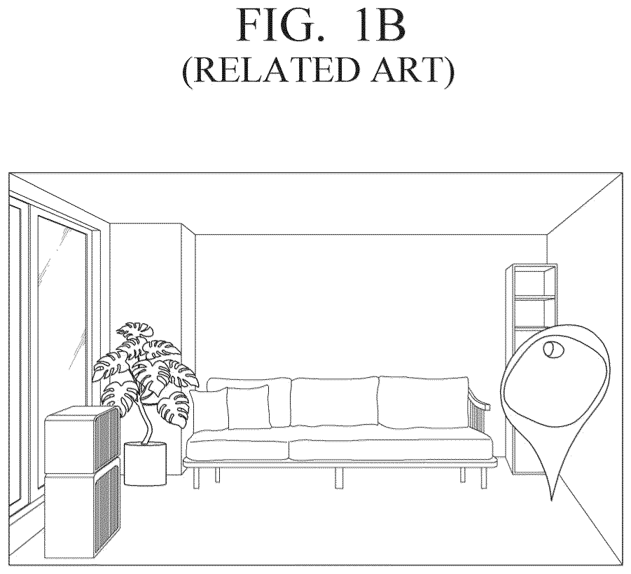

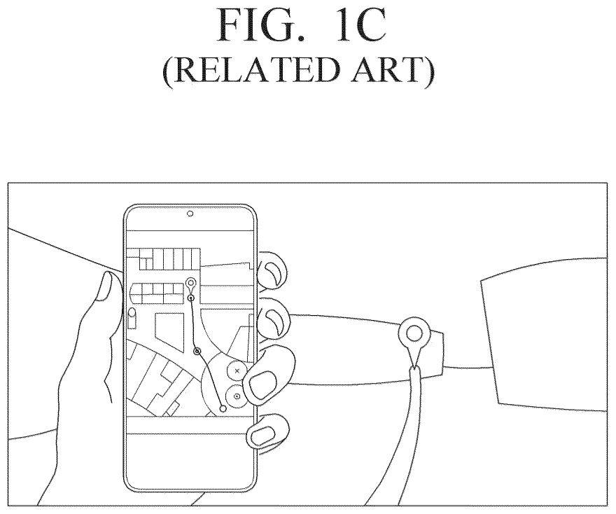

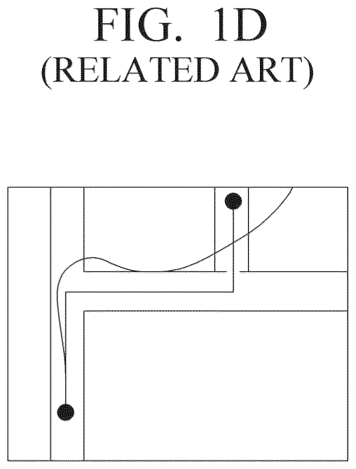

FIGS. 1A, 1B, 1C and 1D illustrate scenarios depicting an inaccurate location of a target on a related user equipment (UE). Because the plurality of sensors is present on one of a plurality of foldable portions, the location of the target displayed on another foldable portion is shown in erroneous directions. That is, the location shown on another foldable portion is an inaccurate location. For example, if a foldable phone is open for approximately 20 degrees and the navigation application instructs the user to go north, which may be directly in front of the user. The plurality of sensors on another foldable portion of the foldable phones would identify the direction north as being 20 degrees to the left. As a result, the user would be guided to move towards the left diagonal instead of being instructed to move straight ahead, thus providing the inaccurate location. As shown in FIG. 1D, the configuration leads to additional drift while providing the location of the target to the user, which is inaccurate, thus confusing the user.

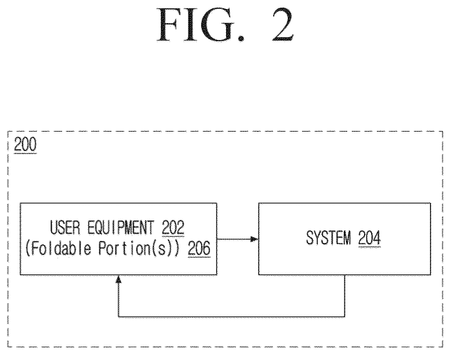

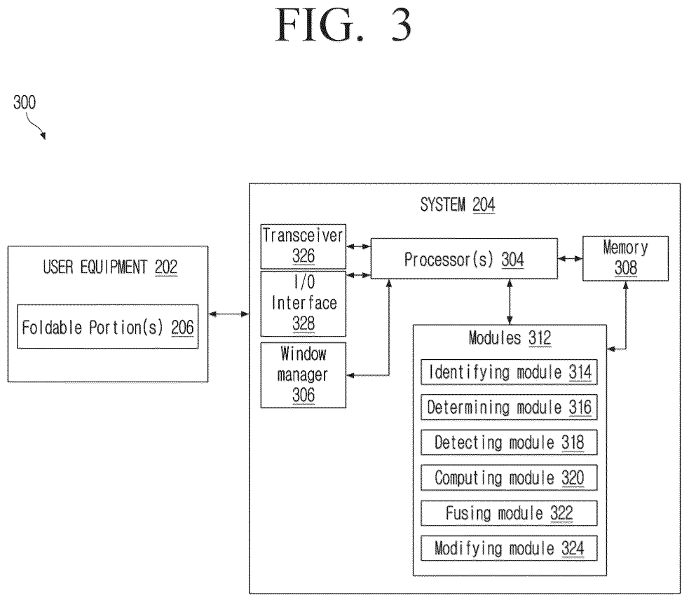

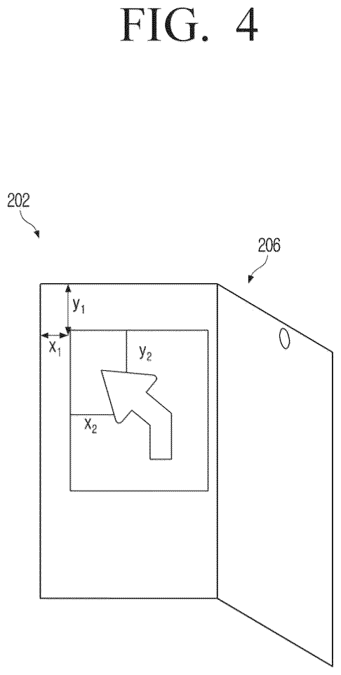

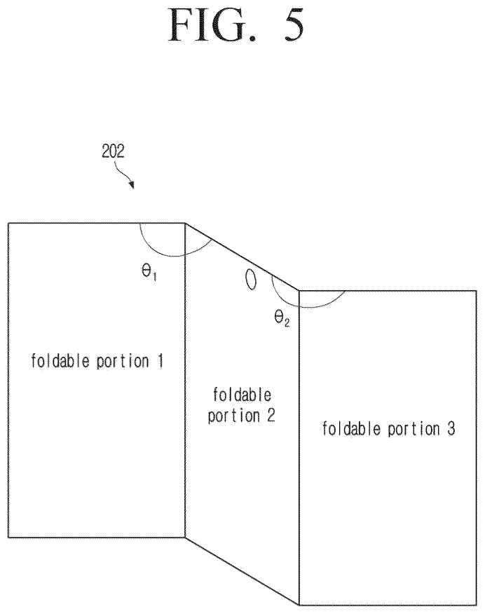

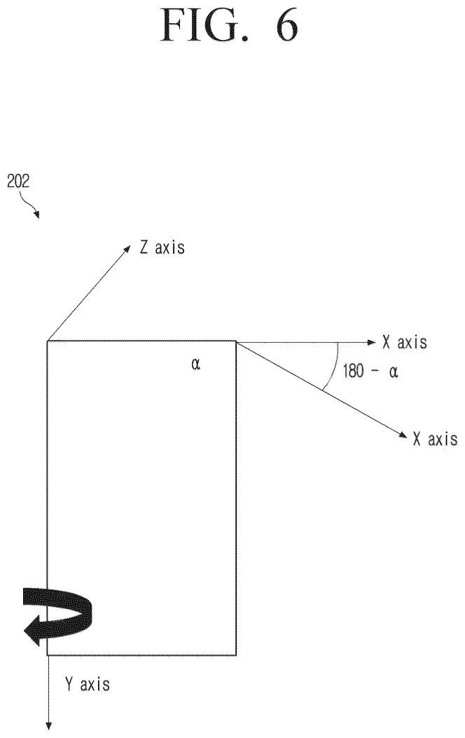

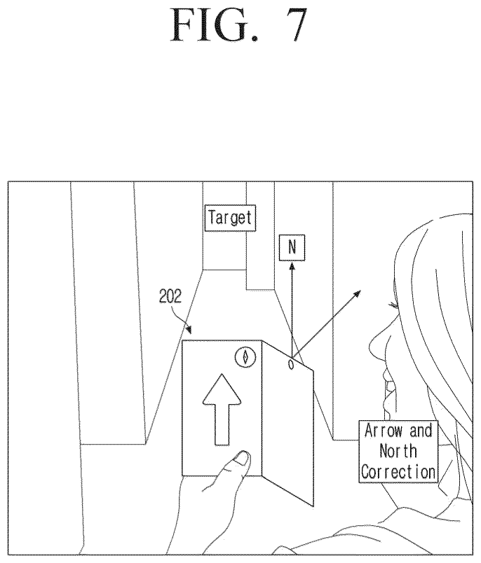

FIG. 2 illustrates an environment 200 of a system 204 communicably coupled with a user equipment (UE) 202 having a plurality of foldable portions 206, in accordance with an embodiment. FIG. 3 illustrates a block diagram 300 of the system 204 in connection with the user equipment 202, in accordance with an embodiment. FIG. 4 illustrates detecting at least one element of an application on a first foldable portion from the plurality of foldable portions 206 by the system 204 in the UE 202, in accordance with an embodiment. FIG. 5 illustrates an angle between the first foldable portion, which does not have a plurality of sensors, and a second foldable portion from the plurality of foldable portions 206 which does have the plurality of sensors, in accordance with an embodiment. FIG. 6 illustrates a rotation matrix based on the angle between the first foldable portion and the second foldable portion from the plurality of foldable portions 206, in accordance with an embodiment. FIG. 7 illustrates at least one element of the application, in the correct format, on the first foldable portion from plurality of foldable portions 206 of the UE 202, in accordance with an embodiment.

In an embodiment, the user equipment 202 may be a foldable smartphone, or any other foldable electronic device having a navigation application, virtual reality application or augmented reality application, without departing from the scope of the present disclosure. In an embodiment, the user equipment 202 includes the plurality of foldable portions 206. In an embodiment, at least one of the plurality of foldable portions 206 may have a display portion, without departing from the scope of the present disclosure.

Further, the system 204 is configured to provide the at least one element, in a correct format, on the UE 202, without departing from the scope of the present disclosure.

In an embodiment, the system 204 may include, but is not limited to, at least one processor (referred here as one or more processor and/or a processor) 304, a memory 308, and a plurality of modules (i.e., circuits) 312 among other examples which are explained in detail in subsequent paragraphs.

The system 204 may include an Input/Output (I/O) interface 328, a transceiver (i.e., transmitter and receiver) 326, and a window manager (i.e., a window management circuit) 306. Further, in some embodiments the system 204 may be implemented as a standalone entity at a server/cloud architecture, and the system 204 may be in communication with multiple user equipment to receive data from each of the multiple user equipment, and the details provided below with respect to the system 204 and the user equipment 202 is applicable for the system 204 and the multiple user devices as well.

In an embodiment, the processor 304 may be operatively coupled to each of the I/O interface 328, the plurality of modules 312, the transceiver 326, and the memory 308. In one embodiment, the processor 304 may include a graphical processing unit (GPU) and/or an AI Engine (AIE). In one embodiment, the processor 304 may include at least one data processor for executing processes in a virtual storage area network. The processor 304 may include specialized processing units (i.e., specialized processing circuits) such as, integrated system (bus) controllers, memory management control units (i.e., memory management controllers), floating point units (i.e., floating point circuits), graphics processing units (i.e., graphics processors), digital signal processing units (i.e., digital signal processors), etc. In one embodiment, the processor 304 may include a central processing unit (i.e., central processor) (CPU), a graphics processing unit (i.e., graphics processor) (GPU), or both. The processor 304 may be one or more general processors, digital signal processors, application-specific integrated circuits, field-programmable gate arrays, servers, networks, digital circuits, analog circuits, combinations thereof, or other devices for analyzing and processing data. The processor 304 may execute a software program, such as code generated manually (i.e., programmed) to perform the desired operation.

The processor 304 may be disposed in communication with one or more input/output (I/O) devices via the I/O interface 328. In some embodiments, the processor 304 may communicate with the UE 202 using the I/O interface 328. In some embodiments, the I/O interface 328 may be implemented within the user equipment 202. The I/O interface 328 may employ communication code-division multiple access (CDMA), high-speed packet access (HSPA+), global system for mobile communications (GSM), long-term evolution (LTE), WiMax, or the like, etc. In an embodiment, the I/O interface 328 may enable input and output to and from the system 204 using suitable devices such as, but not limited to, display, keyboard, mouse, touch screen, microphone, speaker, and so forth.

Using the I/O interface 328, the system 204 may communicate with one or more I/O devices, specifically, the user equipment 202, to which the system 204 provides the at least one element, in the correct format. For example, the input device may include an antenna, microphone, touch screen, touchpad, storage device, transceiver, video device/source, etc. The output devices may include a video display (e.g., cathode ray tube (CRT), liquid crystal display (LCD), light-emitting diode (LED), plasma, Plasma Display Panel (PDP), Organic light-emitting diode display (OLED) or the like), audio speaker, etc.

The processor 304 may be disposed in communication with a communication network via a network interface. In an embodiment, the network interface may be the I/O interface 328. The network interface may connect to the communication network to enable the connection of the system 204 with the UE 202. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 204 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

The transceiver 326 may be configured to receive and/or transmit signals to and from the UE 202. In one embodiment, the database may be configured to store the information as required by the plurality of modules 312 and the processor 304 to perform one or more functions for providing the at least one element, in the correct format, on the UE 202.

In some embodiments, the memory 308 may be communicatively coupled to the processor 304. The memory 308 may be configured to store data, and instructions executable by the processor 304. In one embodiment, the memory 308 may be provided within the UE 202. In another embodiment, the memory 308 may be provided within the system 204 being remote from the UE 202. In yet another embodiment, the memory 308 may communicate with the processor 304 via a bus within the system 204. In yet another embodiment, the memory 308 may be located remote from the processor 304 and may be in communication with the processor 304 via a network. The memory 308 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like.

In one example, the memory 308 may include a cache or random-access memory for the processor 304. In alternative examples, the memory 308 is separate from the processor 304, such as a cache memory of a processor, the system memory, or other memory. The memory 308 may be an external storage device or database for storing data. The memory 308 may be operable to store instructions executable by the processor 304. The functions, acts or tasks illustrated in the figures or described may be performed by the programmed processor 304 for executing the instructions stored in the memory 308. The functions, acts or tasks are independent of the particular type of instruction set, storage media, processor or processing strategy and may be performed by software, hardware, integrated circuits, firmware, microcode and the like, operating alone or in combination. Likewise, processing strategies may include multiprocessing, multitasking, parallel processing, and the like.

In some embodiments, the plurality of modules 312 may be included within the memory 308. The memory 308 may further include a database to store data. The plurality of modules 312 may include a set of instructions that may be executed to cause the system 204, in particular, the processor 304 of the system 204, to perform any one or more of the methods/processes disclosed herein. The plurality of modules 312 may be configured to perform the operations of the present disclosure using the data stored in the database. For instance, the plurality of modules 312 may be configured to perform the operations disclosed in FIGS. 4-7.

In an embodiment, each of the plurality of modules 312 may be a hardware which may be outside the memory 308. Further, the memory 308 may include an operating system for performing one or more tasks of the system 204, as performed by a generic operating system.

In one example, the modules 312 may include an identifying module (i.e., an identifying circuit) 314, a determining module (i.e., a determining circuit) 316, a detecting module (i.e., a detecting circuit) 318, a computing module (i.e., a computing circuit) 320, a fusing module (i.e., a fusing circuit) 322, and a modifying module (i.e., a fusing circuit) 324. Each of the identifying module 314, the determining module 316, the detecting module 318, the computing module 320, the fusing module 322, and the modifying module 324 may be in communication with each other. Further, each of the identifying module 314, the determining module 316, the detecting module 318, the computing module 320, the fusing module 322, and the modifying module 324 may be in communication with the processor 304.

Further, the present disclosure contemplates a computer-readable medium that includes instructions or receives and executes instructions responsive to a propagated signal. Further, the instructions may be transmitted or received over the network via a communication port or interface or using a bus. The communication port or interface may be a part of the processor 304 or may be a separate component. The communication port may implemented using hardware.

The communication port may be configured to connect with a network, external media, the display, or any other components in the system, or combinations thereof. The connection with the network may be a physical connection, such as a wired Ethernet connection or may be established wirelessly. Likewise, the additional connections with other components of the system 204 may be physical or may be established wirelessly. The network may alternatively be directly connected to a bus. For the sake of brevity, the architecture and standard operations of the memory 204, the processor 304, the transceiver 326, and the I/O interface 328 are not discussed in detail.

Further, in an embodiment, the working of the system 204 to provide at least one element, in the correct format, on the UE 202 is explained in detail in subsequent paragraphs in conjunction with FIG. 3 to FIG. 7.

The processor 304, in conjunction with the identifying module 314, the determining module 316, the detecting module 318, the computing module 320, the fusing module 322, and the modifying module 324 may be configured to perform specific operations explained in subsequent paragraphs.

In an embodiment, the identifying module 314 may be configured to identify a current state of the UE 202. In an embodiment, the current state of the UE 202 includes an angular orientation between the first foldable portion and the second foldable portion from plurality of foldable portions 206. For example, the angular orientation between the first foldable portion and the second foldable portion from the plurality of foldable portions 206 may be identified as being less than 180 degrees, without departing from the scope of the present disclosure.

In an embodiment, after identifying the current state, the window manager 306 may be configured to determine coordinates/boundaries of an application running on the UE 202. In another embodiment, the window manager 306 may be configured to provide coordinates/boundaries of a view, without departing from the scope of the present disclosure. The view is an area within a window of an application where data from the application is projected on the UE 202, without departing from the scope of the present disclosure. Further, in an embodiment, after determining the coordinated/boundaries and based on the identification, the detecting module 318 may be configured to determine the at least one element of the application displayed on the first foldable portion from the plurality of foldable portions 206.

In an embodiment, elaborating further, the detecting module 318 may be configured to detect that the application is running on at least a multi-window mode or a full screen mode on the UE 202 based on the boundaries of the application determined by the window manager 306. In an embodiment, the detection of the application running on the at least a multi-window mode or a full screen mode occurs, when the plurality of foldable portions 206 is in an open state, without departing from the scope of the present disclosure. In another embodiment, the detecting module 318 may be configured to detect that the application is running on the at least the multi-window mode or the full screen mode on the UE 202 based on the boundaries of the view determined by the window manager 306.

Further, the detecting module 318 may detect coordinates x₁, y₁ (referring to FIG. 4) of a starting of the application (as shown with a square box in FIG. 4) on the UE 202 based on the determined boundaries of the application. In another embodiment, the detecting module 318 detects the coordinates x₁, y₁ (referring to FIG. 4) of the starting of the application on the UE 202 based on the determined boundaries of the view, without departing from the scope of the present disclosure. In an embodiment, the coordinates x₁, y₁ may be provided from a view properties application, without departing from the scope of the present disclosure. In an embodiment, x₁ represents a left coordinate of the application and y₁ represents a top coordinate of the application, without departing from the scope of the present disclosure. Further, the detected coordinates x₁, y₁ may be summed up with coordinates x₂, y₂ (referring to FIG. 4), associated with a relative position of the application, as (x₁+x₂, y₁+y₂). The coordinates x₂, y₂ on the relative position of the application may be determined with respect to a center position of a view of the at least one element of the application. In an embodiment, the coordinates x₂, y₂ may be also determined based on a margin and padding of the view, without departing from the scope of the present disclosure.

The detecting module 318 may further detect the at least one element of the application on the first foldable portion from the plurality of foldable portions 206 by computing the summation along with a width of the plurality of foldable portions 206 and a number of foldable portions. The detection may be performed based on a Formula 1 as provided below:

$${display}_{num} = ( ⌊ \frac{( {x}_{1} + {x}_{2} )}{Width of Screen} \times Number of displays ⌋ + 1 ) \qquad Formula 1$$

In an embodiment, the plurality of foldable portions 206 may be also referred as a plurality of display portions, without departing from the scope of the present disclosure. In an embodiment, the width of the screen represents a total width of the plurality of foldable portions 206, without departing from the scope of the present disclosure. In one example, a relation between the coordinates and detection of the plurality of foldable portions 206 is shown in Table 1:

TABLE 1

| View Coordinates | Detection of the Plurality |
|---|---|
| (x₁ + x₂, y₁ + y₂) | of Foldable Portions |
| 120, 450 | Foldable portion 1 |
| 1024, 1472 | Foldable portion 2 |
| 784, 973 | Foldable portion 1 |
| 450, 798 | Foldable portion 1 |

Further, in an embodiment, the at least one element of the application may be operated in a multi-window mode on the first foldable portion.

In an embodiment, based on the detection, the identifying module 314 identifies whether the first foldable portion (i.e., the portion on which the at least one element of the application is displayed) includes the plurality of sensors. In an embodiment, the plurality of sensors includes at least one of an accelerometer sensor, a gyroscope, a magnetometer, an Inertial Measurement Unit (IMU) sensor, and an Ultra-Wide Band (UWB) sensor.

In an embodiment, identifying module 314 identifies that the first foldable portion does not have the plurality of sensors (as shown in FIG. 4). Further, depending on the identification, the determining module 316 determines whether the at least one element of the application is operating (i.e., displayed) on the first foldable portion (as shown in FIG. 4). For example, the determining module 316 may determine that the at least one element of the application is displayed on the first foldable portion (as shown in FIG. 4), and that the first foldable portion does not have the plurality of sensors (i.e., that the plurality of sensors are provided in a different foldable portion).

Further, in an embodiment, each of the plurality of foldable portions 206 may include a hinge sensor configured to indicate the folding of each foldable portions, which may be used to identify one or more folding angles, without departing from the scope of the present disclosure (as shown in FIG. 5). For example, the plurality of foldable portions 206 may include N portions and the plurality of sensors may be on Nth foldable portion. Angle θ₁ is an angle formed between a foldable portion 1 and foldable portion 2. Similarly, angle θ₂ formed between the foldable portion 2 and a foldable portion 3 and so on. Then the angle of the Nth foldable portion with a Mth foldable portion, where M<N and M>N would be:

$$Angle ( α ) = \begin{matrix}{θ}_{M} + {\sum }_{y = M + 1}^{N} ( {θ}_{y} - 1 \; 80 ) where M > N \\ {\sum }_{y = M - 1}^{N} ( 180 - {θ}_{y} ) where M < N\end{matrix} \qquad Formula 2$$

In an embodiment, M represents the first foldable portion and N represents the second foldable portion. In an embodiment, θ represents the hinge sensor angle between each of the plurality of foldable portions 206 provided in the table 2 below:

TABLE 2
Hinge Sensor Values

150
117
88
65

In an embodiment, α represents the angle between the first foldable portion not having the plurality of sensors and the second foldable portion having the plurality of sensors. In another embodiment, the abovementioned formula 2 may be used/applied in any sequence of the plurality of foldable portions 206 accordingly.

In an embodiment, based on the determination and identification of the angle between the first foldable portion not having the plurality of sensors and the second foldable portion having the plurality of sensors, the fusing module 322 may fuse data from the plurality of sensors to the at least one element of the application displayed on the foldable portion on which the at least one element is operated. In an embodiment, the at least one element of the application may be operated on the first foldable portion. Particularly, the determining module 316 determines a rotation matrix based on the identified angular orientation between the first foldable portion and the second foldable portion from as shown in FIG. 6. Further, the computing module 320 may be configured to compute the rotation matrix with an input from the plurality of sensors. Subsequently, the fusing module 322 may fuse data corresponding to the at least one element of the application, operating on the first foldable portion, from the second foldable portion, based on the computation. For better understanding of the determination of the rotation matrix, one example is provided in the subsequent paragraph.

In one example, the plurality of foldable portions 206 rotates in a Y axis, so the rotation matrix is also determined for rotation in the Y axis. Further, from the Formula 2, Angle (α) is determined/identified and thus, the angle between negative X axis of the current foldable portion and the plurality of sensors, for the rotation matrix, is 180-α. Further, the rotation matrix may be given by Formula 3 as:

$$Rot . {Mat}_{Y axis} = [ \begin{matrix}cos ( 180 - α ) & 0 & sin ( 1800 - α ) & 0 \\ 0 & 1 & 0 & 0 \\ - s in ( 180 - α ) & 0 & cos ( 180 - α ) & 0 \\ 0 & 0 & 0 & 1\end{matrix} ] = [ \begin{matrix}- cos ( α ) & 0 & sin ( α ) & 0 \\ 0 & 1 & 0 & 0 \\ - s in ( α ) & 0 & - cos ( α ) & 0 \\ 0 & 0 & 0 & 1\end{matrix} ] \qquad Formula 3$$

Further, the updated value of the plurality of sensors may be provided by the following Formula 4:

$$Magnetic {Field}_{updated values} = Rot . {Mat}_{y axis} \cdot Magnetic {Field}_{current values} And Uwb {Sensor}_{updated values} = Rot . {Mat}_{y axis} \cdot Uwb {Sensor}_{current values} \qquad Formula 4$$

Further, after determining the required values from the abovementioned formulas, the relevant table is provided below:

TABLE 3

| | | | Yaw, Pitch | Yaw, Pitch and |
|---|---|---|---|---|
| | | Magnetic Data for | and roll | roll for foldable |
| | Magnetic | foldable portion | provided by | portion |
| α | Sensor data | w/o sensor | UWB sensor | w/o sensor |
| 150 | −12.58, −12.76, | −6.08, −12.76, | 61, 298, 343 | 13, 298, 343 |
| | −9.62 | −14.62 | | |
| 117 | −8.91, −16.21, | −8.99, −16.21, | 90, 283, 307 | 9, 283, 307 |
| | 5.55 | −5.42 | | |
| 88 | −6.60, −15.62, | −8.12, −15.62, | 90, 286, 282 | 312 (or −48), |
| | 8.35 | −6.89 | | 286, 282 |
| 65 | −1.64, −16.36, | −8.88, −16.36, | 97, 283, 264 | 307 (or −63), |
| | 10.05 | −4.98 | | 283, 264 |

The determination of the rotation matrix assists in determining and transforming values from the first foldable portion to the second foldable portion.

In an embodiment, based on the fused data, the modifying module 324 modifies the at least one element to provide the correct format of the at least one element on the first foldable portion from the plurality of foldable portions 206 of the UE 202 in the current state of UE 202 as shown in FIG. 7. In an embodiment, FIG. 7 illustrates representation of the at least one element of the application, in the correct format, on the first foldable portion from the plurality of foldable portions 206 of the UE 202, without departing from the scope of the present disclosure.

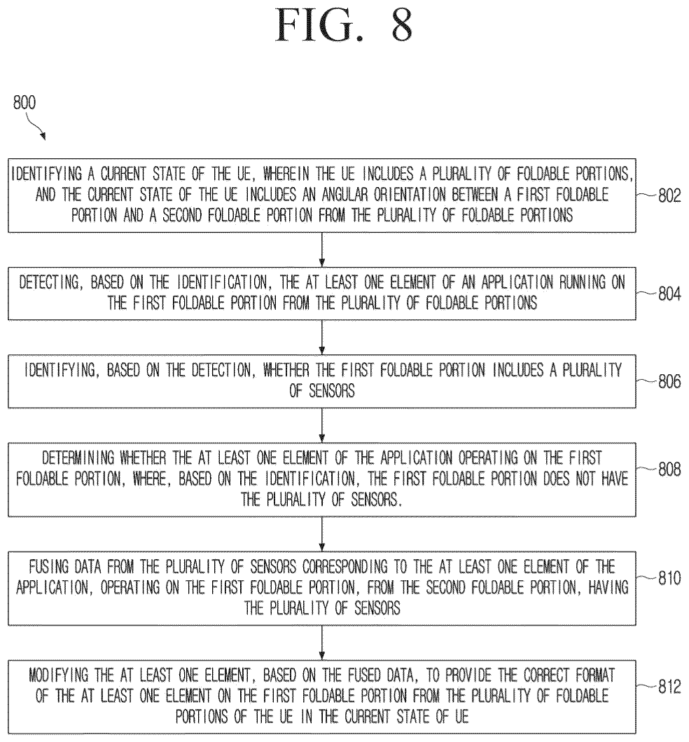

FIG. 8 illustrates a method 800 performed by the system 204, in accordance with an embodiment.

The method 800 can be performed by programmed computing devices, for example, based on instructions retrieved from non-transitory computer readable media. The computer readable media can include machine-executable or computer-executable instructions to perform all or portions of the described method. The computer readable media may be, for example, digital memories, magnetic storage media, such as magnetic disks and magnetic tapes, hard drives, or optically readable data storage media.

The method 800 includes a series of operations shown at operation 802 through operation 812 of FIG. 8. The method 800 may be performed by the system 204 in conjunction with the modules 312, the details of which are explained in conjunction with FIGS. 3 to 7 and the same are not repeated here for the sake of brevity in the present disclosure. The method 800 begins at operation 802.

At operation 802, the method 800 includes identifying the current state of the UE 202. The UE includes the plurality of foldable portions 206. Further, the current state of the UE 202 includes the angular orientation between the first foldable portion and the second foldable portion from the plurality of foldable portions 206. The angular orientation between the first foldable portion and the second foldable portion from the plurality of foldable portions 206 is identified as being less than 180 degrees.

The method 800 includes determining coordinates/boundaries of the application running on the UE 202, by the window manager 306, prior to detecting the at least one element of the application operating on the first foldable portion from the plurality of foldable portions 206. Further, once the coordinates/boundaries are determined, at operation 804, the method 800 includes detecting, based on the identification, the at least one element of the application running on the first foldable portion from the plurality of foldable portions 206.

Further, the method 800 includes detecting that the application is running on the multi-window mode or the full screen mode on the UE 202 based on the boundaries of the application determined by the window manager 306. For example, it may be detected that the at least one element of the application is operated in the multi-window mode on the first foldable portion. The method 800 includes detecting the coordinates x₁, y₁ of the starting of the application on the UE 202 based on the determined boundaries of the application. Further, the detected coordinates x₁, y₁ may be summed with the coordinates x₂, y₂ associated with the relative position of the application as (x₁+x₂, y₁+y₂). The coordinates x₂, y₂ of the relative position of the application may be determined with respect to the center position of the view of the at least one element of the application. In an embodiment, the coordinates x₂, y₂ may be also determined based on the margin and padding of the view, without departing from the scope of the present disclosure. The method 800 includes detecting the at least one element of the application on the first foldable portion from the plurality of foldable portions 206 by computing the summation along with the width of the plurality of foldable portions 206 and the number of the plurality of foldable portions 206.

At operation 806, the method 800 includes identifying, based on the detection, whether the first foldable portion includes the plurality of sensors. In an embodiment, the plurality of sensors includes the at least one of the accelerometer sensor, the gyroscope, the magnetometer, the Inertial Measurement Unit (IMU) sensor, and the Ultra-Wide Band (UWB) sensor.

At operation 808, the method 800 includes determining whether the at least one element of the application operating on the first foldable portion, where, based on the identification, the first foldable portion from the plurality of foldable portions 206 does not have the plurality of sensors.

At operation 810, the method 800 includes fusing data from the plurality of sensors corresponding to the at least one element of the application, operating on the first foldable portion, from the second foldable portion, having the plurality of sensors. The method 800 includes determining the rotation matrix based on the identified angular orientation between the first foldable portion and the second foldable portion. The method 800 includes computing the rotation matrix with the input from the plurality of sensors. The method 800 includes fusing data corresponding to the at least one element of the application, operating on the first foldable portion, from the second foldable portion, based on the computation.

At operation 812, the method 800 includes modifying the at least one element, based on the fused data, to provide the correct format of the at least one element on the first foldable portion from the plurality of foldable portions 206 of the UE 202 in the current state of UE 202.

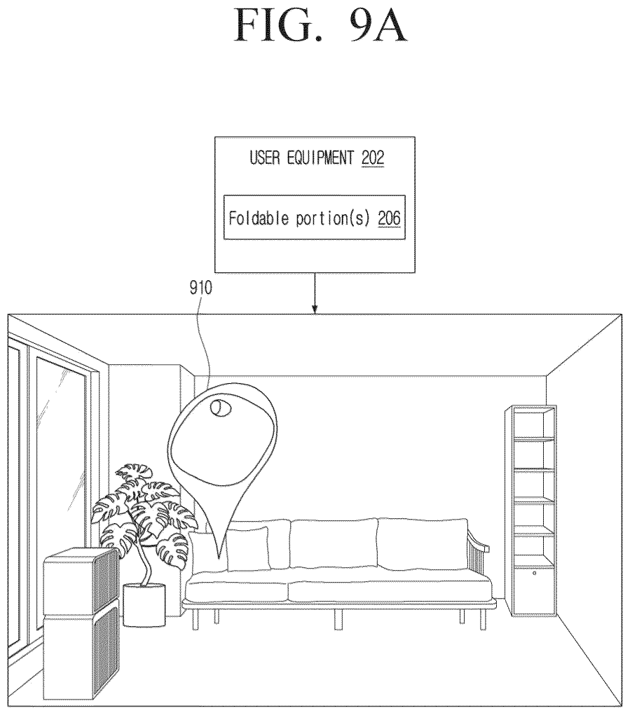

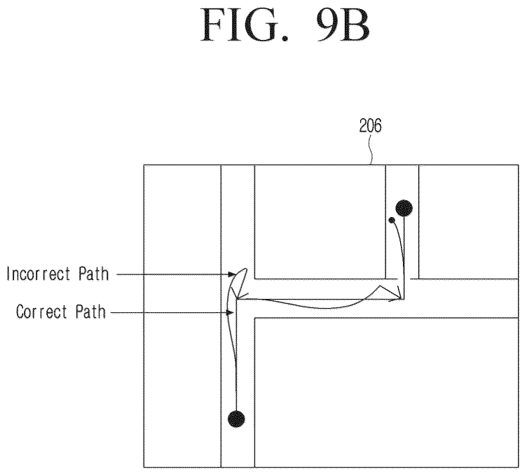

FIGS. 9A and 9B illustrate multiple use cases of the system 204 providing the at least one element, in the correct format, on the UE 202, without departing from the scope of the present disclosure, in accordance with an embodiment.

Referring to FIG. 9A, the UE 202 may be adapted to locate lost things, for example, smart tags, correctly in a premises accurately, unlike related configurations, thus providing comfort to the user using the UE 202. As shown in FIG. 9A, the UE 202 may display, on one of the foldable units, an image of an area and at least one element 910 in the correct format indicating a location of a smart tag. Further, the present subject matter also assists in locating the target in the premises, like, shopping complex, correctly on the UE 202, unlike the related configurations, thus ensuring comfort to the user.

Further, referring to FIG. 9B, the at least one element in the correct format on the UE 202 may be adapted to locate the target in the map correctly by showing correct path and eliminate the drifting unlike as the related configurations which shows the incorrect path, thus ensuring comfort to the user.

As would be gathered, the system 204 and the method 800 as disclosed provide a comprehensive approach to provide the at least one element, in the correct format, on the UE 202. The present configuration provides the at least one element on the first foldable portion from the plurality of foldable portions 206 not having the plurality of sensors, thus ensuring the correct format of the at least one element on the plurality of foldable portions 206 irrespective of the presence of the plurality of sensors on one of the plurality of foldable portions 206. This configuration provides the accurate location of the target to the user, thus ensuring the comfort of the user.

In some embodiments, each of the components represented by a block as illustrated in FIG. 3 may be implemented as various numbers of hardware and/or firmware structures that execute respective functions described above, according to example embodiments. For example, at least one of these components may include various hardware components including a digital circuit, a programmable or non-programmable logic device or array, an application specific integrated circuit (ASIC), transistors, capacitors, logic gates, or other circuitry using use a direct circuit structure, such as a memory, a processor, a logic circuit, a look-up table, etc., that may execute the respective functions through controls of one or more microprocessors or other control apparatuses. Also, at least one of these components may further include or may be implemented by a processor such as a central processing unit (CPU) that performs the respective functions, a microprocessor, or the like. Functional aspects of example embodiments may be implemented in algorithms that execute on one or more processors. Furthermore, the components, elements, modules or units represented by a block or processing steps may employ any number of related art techniques for electronics configuration, signal processing and/or control, data processing and the like.

While aspects of embodiments have been particularly shown and described, it will be understood that various changes in form and details may be made therein without departing from the spirit and scope of the following claims.

What is claimed is:

1. A method of controlling a user equipment (UE) including a plurality of foldable portions, the method comprising:
identifying a current state of the UE, wherein the current state of the UE includes an angular orientation between a first foldable portion and a second foldable portion from among the plurality of foldable portions;
detecting at least one element of an application running on the first foldable portion;
identifying, based on the detecting, whether the first foldable portion includes a plurality of sensors;
determining whether the at least one element is displayed on the first foldable portion, based on the identifying indicating the first foldable portion does not have the plurality of sensors;
fusing data from the plurality of sensors to data corresponding to the at least one element of the application; and
controlling display of the at least one element based on the fused data to provide a correct format of the at least one element on the first foldable portion.

2. The method as claimed in claim 1, wherein the angular orientation between the first foldable portion and the second foldable portion from the plurality of foldable portions is less than 180 degrees.

3. The method The method as claimed in claim 1, wherein the plurality of sensors includes any one or any combination of an accelerometer sensor, a gyroscope, a magnetometer, an inertial sensor, and an ultra-wideband positioning sensor.

4. The method as claimed in claim 1, wherein the at least one element of the application is operated in a multi-window mode on the first foldable portion.

5. The method as claimed in claim 1, further comprising, prior to detecting the at least one element of the application operating on the first foldable portion from the plurality of foldable portions, determining boundaries of the application running on the UE.

6. The method as claimed in claim 1, wherein the detecting the at least one element comprises:
determining boundaries of the application running on the UE;
detecting that the application is running in a multi-window mode or a full screen mode on the UE based on the boundaries of the application;
detecting first coordinates of the application on the UE based on the determined boundaries of the application, and summing the first coordinates with second coordinates associated with a relative position of the application, wherein the second coordinates are determined with respect to a center position of a view of the at least one element; and
detecting the at least one element of the application on the first foldable portion based on a width of the plurality of foldable portions and a number of the plurality of foldable portions.

7. The method as claimed in claim 1, wherein the fusing the data comprises:
determining a rotation matrix based on the angular orientation between the first foldable portion and the second foldable portion; and
computing the rotation matrix based on an input from the plurality of sensors to fuse the data corresponding to the at least one element of the application.

8. A system for providing at least one element on a user equipment (UE) comprising a plurality of foldable portions, the system comprising:
a memory; and
at least one processor communicatively coupled with the memory, and configured to:
identify a current state of the UE, wherein the current state of the UE includes an angular orientation between a first foldable portion and a second foldable portion from among the plurality of foldable portions;
detect the at least one element of an application running on the first foldable portion;
identify, based on the at least one element being detected as running on the first foldable portion, whether the first foldable portion includes a plurality of sensors;
determine whether the at least one element is displayed on the first foldable portion, based on identifying the first foldable portion does not have the plurality of sensors;
fuse, based on determining the first foldable portion does not have the plurality of sensors, data from the plurality of sensors to data corresponding to the at least one element of the application; and
control display of the at least one element based on the fused data to provide a correct format of the at least one element on the first foldable portion.

9. The system as claimed in claim 8, wherein the at least one processor is further configured to detect the at least one element based on identifying the angular orientation between the first foldable portion and the second foldable portion from the plurality of foldable portions is less than 180 degrees.

10. The system as claimed in claim 8, wherein the plurality of sensors comprises any one or any combination of an accelerometer sensor, a gyroscope, a magnetometer, an inertial sensor, and an ultra-wideband positioning sensor.

11. The system as claimed in claim 8, wherein the at least one element of the application is operated in a multi-window mode on the first foldable portion.

12. The system as claimed in claim 8, wherein the at least one processor is further configured to, prior to detecting the at least one element of the application operating on the first foldable portion from the plurality of foldable portions, determine boundaries of the application running on the UE.

13. The system as claimed in claim 8, wherein the at least one processor is further configured to:
determine boundaries of the application running on the UE;
detect that the application is running in a multi-window mode or a full screen mode on the UE based on the boundaries of the application;
detect first coordinates of the application on the UE based on the determined boundaries of the application, and sum the first coordinates with second coordinates associated with a relative position of the application, wherein the second coordinates are determined with respect to a center position of a view of the at least one element; and
detect the at least one element of the application on the first foldable portion based on a width of the plurality of foldable portions and a number of the plurality of foldable portions.

14. The system as claimed in claim 8, wherein the at least one processor is further configured to:
determine a rotation matrix based on the angular orientation between the first foldable portion and the second foldable portion;
compute the rotation matrix based on an input from the plurality of sensors to fuse the data corresponding to the at least one element of the application.

15. An apparatus for controlling display of information on a user equipment comprising a plurality of foldable portions and a sensor provided in a first foldable portion of the plurality of foldable portions, the apparatus comprising:
a memory; and
at least one processor communicatively coupled with the memory and configured to:
identify whether an application is running on the user equipment to display a first element based on an output of the sensor;
modify, based on the first element being displayed on a second foldable portion of the plurality of foldable portions, display of the first element based on an angle between the first foldable portion and the second foldable portion.

16. The apparatus as claimed in claim 15, wherein the at least one processor is further configured to maintain display of a second element on the first foldable portion based on the output of the sensor without modification.

17. The apparatus as claimed in claim 15, wherein the at least one processor is further configured to move display of the first element from the second foldable portion to the first foldable portion, and based on the first element being displayed on the first foldable portion, control the first element to be displayed independent of the angle between the first foldable portion and the second foldable portion.

18. The apparatus as claimed in claim 15, wherein the output of the sensor indicates motion of the user equipment.

19. The apparatus as claimed in claim 15, wherein the output of the sensor indicates a first orientation corresponding to the first foldable portion.

20. The apparatus as claimed in claim 19, wherein the at least one processor is further configured to identify a second orientation corresponding to the second foldable portion based on the output of the sensor and the angle between the first foldable portion and the second foldable portion.
